(19) United States
(12) Patent Application Publication
(10) Pub. No.: US 2020/0412656 A1
(43) Pub. Date: Dec. 31, 2020

(54) DATA RATE MANAGEMENT OF A MULTI-RAT USER EQUIPMENT

(71) Applicant: QUALCOMM Incorporated, San Diego, CA (US)

(72) Inventors: Hee Jun PARK, San Diego, CA (US); Vivek KHANNA, San Diego, CA (US)

(21) Appl. No.: 16/907,141

(22) Filed: Jun. 19, 2020

Related U.S. Application Data
(60) Provisional application No. 62/867,203, filed on Jun. 26, 2019.

(51) Int. Cl. H04L 12/825; H04W 28/02; H04W 4/40

(52) U.S. Cl. CPC H04L 47/25; H04W 88/06; H04W 4/40; H04W 28/0231

(57) ABSTRACT

Aspects of the present disclosure relate to monitoring a set of operational conditions to establish a dynamic prioritization of a plurality of RATs. Data rates of the plurality of RATs are managed based in part upon the dynamic prioritization. In some designs, the dynamic prioritization is used to determine a data rate tolerance of each of the plurality of RATs, after which a RAT-specific data rate target for each of the plurality of RATs is determined based at least in part on the determined data rate tolerances and a monitored set of operational conditions, whereby the data rates of the plurality of RATs are managed based on the RAT-specific data rate targets. In some designs, the monitored operational conditions relate to a processing system of a vehicle, or an interior or exterior environment of the vehicle.

### CROSS-REFERENCE TO RELATED APPLICATION

The present application for patent claims the benefit of U.S. Provisional Application No. 62/867,203, entitled “DATA RATE MANAGEMENT OF A MULTI-RATE USER EQUIPMENT”, filed Jun. 26, 2019, assigned to the assignee hereof and hereby expressly incorporated by reference herein in its entirety.

### INTRODUCTION

Various aspects described herein generally relate to data rate management of a user equipment (UE) based at least in part on prioritization of a plurality of radio access technologies (RATs) supported by the UE.

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An aspect of the present disclosure is directed to a method of operating a processing system configured to manage communications in accordance with a plurality of radio access technologies (RATs). The processing system monitors a first set of operational conditions associated with the processing system, an external environment of the processing system, or a combination thereof. The processing system establishes a dynamic prioritization of the plurality of RATs based on the monitored first set of operational conditions. The processing system determines a data rate tolerance of each of the plurality of RATs based at least in part on the dynamic prioritization, monitoring a second set of operational conditions associated with the processing system, the external environment of the processing system, or a combination thereof. The processing system determines a RAT-specific data rate target for each of the plurality of RATs based at least in part on the determined data rate tolerances and the monitored second set of operational conditions. The processing system manages data rates of the plurality of RATs based on the RAT-specific data rate targets.

Another aspect of the present disclosure is directed to a method of operating a processing system associated with a vehicle and configured to manage communications in accordance with a plurality of RATs. The processing system monitors a set of operational conditions associated with the processing system, the vehicle, or a combination thereof. The processing system establishes a dynamic prioritization of the plurality of RATs based on the monitored set of operational conditions. The processing system manages data rates of the plurality of RATs based on the dynamic prioritization.

Another aspect of the present disclosure is directed to a processing system configured to manage communications in accordance with a plurality of RATs, comprising a memory, a transceiver, and at least one processor coupled to the memory and the transceiver and configured to monitor a first set of operational conditions associated with the processing system, an external environment of the processing system, or a combination thereof. The processing system is further configured to establish a dynamic prioritization of the plurality of RATs based on the monitored first set of operational conditions. The processing system is further configured to determine a data rate tolerance of each of the plurality of RATs based at least in part on the dynamic prioritization. The processing system is further configured to monitor a second set of operational conditions associated with the processing system, the external environment of the processing system, or a combination thereof. The processing system is further configured to determine a RAT-specific data rate target for each of the plurality of RATs based at least in part on the determined data rate tolerances and the monitored second set of operational conditions. The processing system is further configured to manage data rates of the plurality of RATs based on the RAT-specific data rate targets.

Another aspect of the present disclosure is directed to a processing system associated with a vehicle and configured to manage communications in accordance with a plurality of radio access technologies (RATs), comprising a memory, a transceiver, and at least one processor coupled to the memory and the transceiver and configured to monitor a set of operational conditions associated with the processing system, the vehicle, or a combination thereof. The processing system is further configured to establish a dynamic prioritization of the plurality of RATs based on the monitored set of operational conditions. The processing system is further configured to manage data rates of the plurality of RATs based on the dynamic prioritization.

Another aspect of the present disclosure is directed to a processing system configured to manage communications in accordance with a plurality of radio access technologies (RATs). The processing system comprises means for monitoring a first set of operational conditions associated with the processing system, an external environment of the processing system, or a combination thereof. The processing system further comprises means for establishing a dynamic prioritization of the plurality of RATs based on the monitored first set of operational conditions. The processing system further comprises means for determining a data rate tolerance of each of the plurality of RATs based at least in part on the dynamic prioritization, and means for monitoring a second set of operational conditions associated with the processing system, the external environment of the processing system, or a combination thereof. The processing system further comprises means for determining a RAT-specific data rate target for each of the plurality of RATs based at least in part on the determined data rate tolerances and the monitored second set of operational conditions. The processing system further comprises means for managing data rates of the plurality of RATs based on the RAT-specific data rate targets.

Another aspect of the present disclosure is directed to a processing system associated with a vehicle and configured to manage communications in accordance with a plurality of RATs. The processing system comprises means for monitoring a set of operational conditions associated with the processing system, the vehicle, or a combination thereof. The processing system further comprises means for establishing a dynamic prioritization of the plurality of RATs based on the monitored set of operational conditions. The processing system further comprises means for managing data rates of the plurality of RATs based on the dynamic prioritization.

Another aspect of the present disclosure is directed to a non-transitory computer-readable medium containing instructions stored thereon, for causing at least one processor in a processing system configured to manage communications in accordance with a plurality of radio access technologies (RATs) to monitor a first set of operational conditions associated with the processing system, an external environment of the processing system, or a combination thereof, establish a dynamic prioritization of the plurality of RATs based on the monitored first set of operational conditions, determine a data rate tolerance of each of the plurality of RATs based at least in part on the dynamic prioritization, monitor a second set of operational conditions associated with the processing system, the external environment of the processing system, or a combination thereof, determine a RAT-specific data rate target for each of the plurality of RATs based at least in part on the determined data rate tolerances and the monitored second set of operational conditions, and manage data rates of the plurality of RATs based on the RAT-specific data rate targets.

Another aspect of the present disclosure is directed to a non-transitory computer-readable medium containing instructions stored thereon, for causing at least one processor in a processing system configured to monitor a set of operational conditions associated with the processing system, the vehicle, or a combination thereof, establish a dynamic prioritization of the plurality of RATs based on the monitored set of operational conditions, and manage data rates of the plurality of RATs based on the dynamic prioritization.

### BRIEF DESCRIPTION OF THE DRAWINGS

A more complete appreciation of the various aspects described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary wireless communications system, according to various aspects.

FIGS. 2A and 2B illustrate example wireless network structures, according to various aspects.

FIG. 3A illustrates an exemplary base station and an exemplary user equipment (UE) in an access network, according to various aspects.

FIG. 3B illustrates an exemplary server according to various aspects.

FIG. 4 illustrates an exemplary wireless communications system according to various aspects of the disclosure.

FIG. 5 illustrates a modem-specific example of the conceptual concurrency scenario of FIG. 4 in accordance with an aspect of the disclosure.

FIGS. 6A-6B illustrates a RAT workload reduction algorithm in accordance with an aspect of the disclosure.

FIG. 7 illustrates a multi-RAT UE in accordance with an aspect of the disclosure.

FIG. 8 illustrates a data rate management procedure in accordance with an aspect of the disclosure.

FIG. 9 illustrates a multi-RAT UE in accordance with an aspect of the disclosure.

FIG. 10 illustrates a data rate management procedure in accordance with an aspect of the disclosure.

FIG. 11 illustrates a vehicle-specific implementation example of part of the process of FIG. 10 in accordance with an aspect of the disclosure.

FIG. 12 illustrates an example implementation of another part of the process of FIG. 10 in accordance with an aspect of the disclosure

FIGS. 13A-13B illustrates an example implementation another part of the process of FIG. 10 in accordance with an aspect of the disclosure.

FIG. 14A illustrates a preconfigured data rate limiting approach in accordance to aspects of the disclosure.

FIG. 14B illustrates a dynamic data rate limiting approach with respect to particular RATs in accordance to aspects of the disclosure.

FIG. 15 illustrates an example UE for implementing the process of FIG. 8 represented as a series of interrelated functional modules in accordance with an aspect of the disclosure.

FIG. 16 illustrates an example UE for implementing the process of FIG. 10 represented as a series of interrelated functional modules in accordance with an aspect of the disclosure.

### DETAILED DESCRIPTION

Various aspects described herein generally relate data rate management of a plurality of radio access technologies (RATs) based in part upon a dynamic prioritization of the plurality of RATs. In some designs, the dynamic prioritization can be based upon a monitored set of operational conditions associated with the processing system, an external environment of the processing system, or a combination thereof. Examples of operational conditions that can contribute to the dynamic prioritization include a RAT-related status of one or more applications configured for execution by the processing system, one or more original equipment manufacturer (OEM) settings defined by an OEM of the processing system, or any combination thereof. In some designs, the processing system is associated with a vehicle, and the operational conditions that can contribute to the dynamic prioritization include one or more in-cabin driving events of the vehicle or one or more exterior driving events of the vehicle.

In some aspects, the dynamic prioritization of the plurality of RATs can be used in part to determine a data rate tolerance of each of the plurality of RATs. In some designs, the data rate tolerance of each of the plurality of RATs corresponds to a degree of data rate reduction over the RAT that can be tolerated while maintaining a threshold RAT-specific user experience level (or, in case of a vehicle implementation, a driver experience level), which may be modeled as a function using the dynamic prioritization as an input. For instance, some RATs may experience significant degradation to user experience level in response to only a slight reduction to date rate, while other RATs experience only a slight degradation to user experience level in response to a significant reduction to data rate.

In some aspects, a second set of operational conditions associated with the processing system, the external environment of the processing system, or a combination thereof can also be monitored. Based on the data rata tolerance of the plurality or RATs, a RAT-specific data rate target (or data rate ‘budget’) for each of the plurality of RATs can be determined monitored second set of operational conditions, and data rates of the plurality of RATs can be managed (e.g., limited) accordingly.

In some aspects, the dynamic prioritization can optionally be used to manage the data rates of the plurality of RATs without necessarily factoring additional parameters such as data rate tolerance, etc., particularly for vehicle-specific implementations.

These and other aspects are disclosed in the following description and related drawings to show specific examples relating to exemplary aspects. Alternate aspects will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects disclosed herein.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user equipment” (or “UE”), “user device,” “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can receive wireless communication and/or navigation signals. These terms are also intended to include devices which communicate with another device that can receive wireless communication and/or navigation signals such as by short-range wireless, infrared, wireline connection, or other connection, regardless of whether satellite signal reception, assistance data reception, and/or position-related processing occurs at the device or at the other device. In addition, these terms are intended to include all devices, including wireless and wireline communication devices, that can communicate with a core network via a radio access network (RAN), and through the core network the UEs can be connected with external networks such as the Internet and with other UEs. Of course, other mechanisms of connecting to the core network and/or the Internet are also possible for the UEs, such as over a wired access network, a wireless local area network (WLAN) (e.g., based on IEEE 802.11, etc.) and so on. UEs can be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

Some wireless communication networks, such as 5G, support operation at very high and even extremely-high frequency (EHF) bands, such as millimeter wave (mmW) frequency bands (generally, wavelengths of 1 mm to 10 mm, or 30 to 300 GHz). These extremely high frequencies may support very high throughput such as up to six gigabits per second (Gbps). One of the challenges for wireless communication at very high or extremely high frequencies, however, is that a significant propagation loss may occur due to the high frequency. As the frequency increases, the wavelength may decrease, and the propagation loss may increase as well. At mmW frequency bands, the propagation loss may be severe. For example, the propagation loss may be on the order of 22 to 27 dB, relative to that observed in either the 2.4 GHz, or 5 GHz bands.

Propagation loss is also an issue in Multiple Input-Multiple Output (MIMO) and massive MIMO systems in any band. The term MIMO as used herein will generally refer to both MIMO and massive MIMO. MIMO is a method for multiplying the capacity of a radio link by using multiple transmit and receive antennas to exploit multipath propagation. Multipath propagation occurs because radio frequency (RF) signals not only travel by the shortest path between the transmitter and receiver, which may be a line of sight (LOS) path, but also over a number of other paths as they spread out from the transmitter and reflect off other objects such as hills, buildings, water, and the like on their way to the receiver. A transmitter in a MIMO system includes multiple antennas and takes advantage of multipath propagation by directing these antennas to each transmit the same RF signals on the same radio channel to a receiver. The receiver is also equipped with multiple antennas tuned to the radio channel that can detect the RF signals sent by the transmitter. As the RF signals arrive at the receiver (some RF signals may be delayed due to the multipath propagation), the receiver can combine them into a single RF signal. Because the transmitter sends each RF signal at a lower power level than it would send a single RF signal, propagation loss is also an issue in a MIMO system.

To address propagation loss issues in mmW band systems and MIMO systems, transmitters may use beamforming to extend RF signal coverage. In particular, transmit beamforming is a technique for emitting an RF signal in a specific direction, whereas receive beamforming is a technique used to increase receive sensitivity of RF signals that arrive at a receiver along a specific direction. Transmit beamforming and receive beamforming may be used in conjunction with each other or separately, and references to “beamforming” may hereinafter refer to transmit beamforming, receive beamforming, or both. Traditionally, when a transmitter broadcasts an RF signal, it broadcasts the RF signal in nearly all directions determined by the fixed antenna pattern or radiation pattern of the antenna. With beamforming, the transmitter determines where a given receiver is located relative to the transmitter and projects a stronger downlink RF signal in that specific direction, thereby providing a faster (in terms of data rate) and stronger RF signal for the receiver. To change the directionality of the RF signal when transmitting, a transmitter can control the phase and relative amplitude of the RF signal broadcasted by each antenna. For example, a transmitter may use an array of antennas (also referred to as a “phased array” or an “antenna array”) that creates a beam of RF waves that can be “steered” to point in different directions, without actually moving the antennas. Specifically, the RF current is fed to the individual antennas with the correct phase relationship so that the radio waves from the separate antennas add together to increase the radiation in a desired direction, while cancelling the radio waves from the separate antennas to suppress radiation in undesired directions.

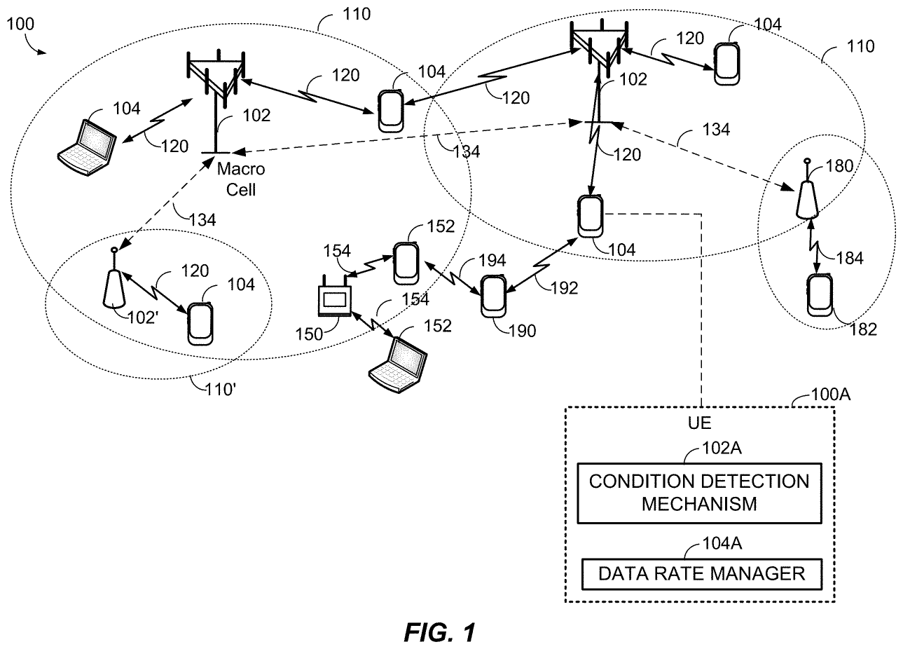

According to various aspects, FIG. 1 illustrates an exemplary wireless communications system 100. The wireless communications system 100 (which may also be referred to as a wireless wide area network (WWAN)) may include various base stations 102 and various UEs 104. The base stations 102 may include macro cells (high power cellular base stations) and/or small cells (low power cellular base stations), wherein the macro cells may include Evolved NodeBs (eNBs), where the wireless communications system 100 corresponds to an LTE network, or gNodeBs (gNBs), where the wireless communications system 100 corresponds to a 5G network or a combination of both, and the small cells may include femtocells, picocells, microcells, etc.

The base stations 102 may collectively form a Radio Access Network (RAN) and interface with an Evolved Packet Core (EPC) or Next Generation Core (NGC) through backhaul links. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, although not shown in FIG. 1, geographic coverage areas 110 may be subdivided into a plurality of cells (e.g., three), or sectors, each cell corresponding to a single antenna or array of antennas of a base station 102. As used herein, the term “cell” or “sector” may correspond to one of a plurality of cells of a base station 102, or to the base station 102 itself, depending on the context.

While neighboring macro cell geographic coverage areas 110 may partially overlap (e.g., in a handover region), some of the geographic coverage areas 110 may be substantially overlapped by a larger geographic coverage area 110. For example, a small cell base station 102′ may have a geographic coverage area 110′ that substantially overlaps with the geographic coverage area 110 of one or more macro cell base stations 102. A network that includes both small cell and macro cells may be known as a heterogeneous network. A heterogeneous network may also include Home eNBs (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a mmW base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 may utilize beamforming 184 with the UE 182 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

The wireless communications system 100 may further include one or more UEs, such as UE 190, that connects indirectly to one or more communication networks via one or more device-to-device (D2D) peer-to-peer (P2P) links. In the aspect of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192-194 may be supported with any well-known D2D radio access technology (RAT), such as LTE Direct (LTE-D), WiFi Direct (WiFi-D), Bluetooth, and so on.

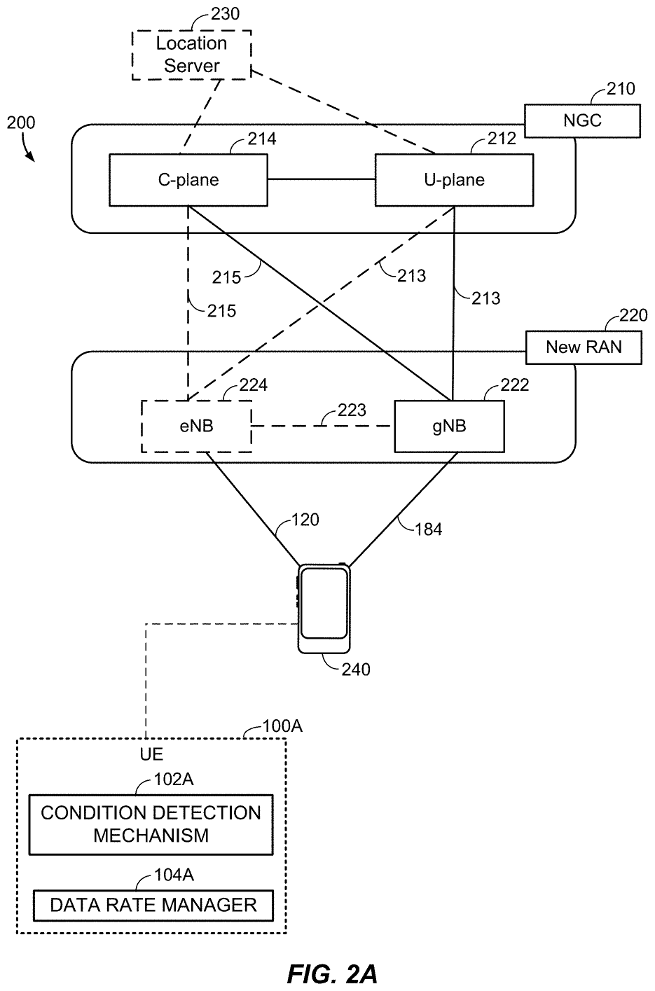

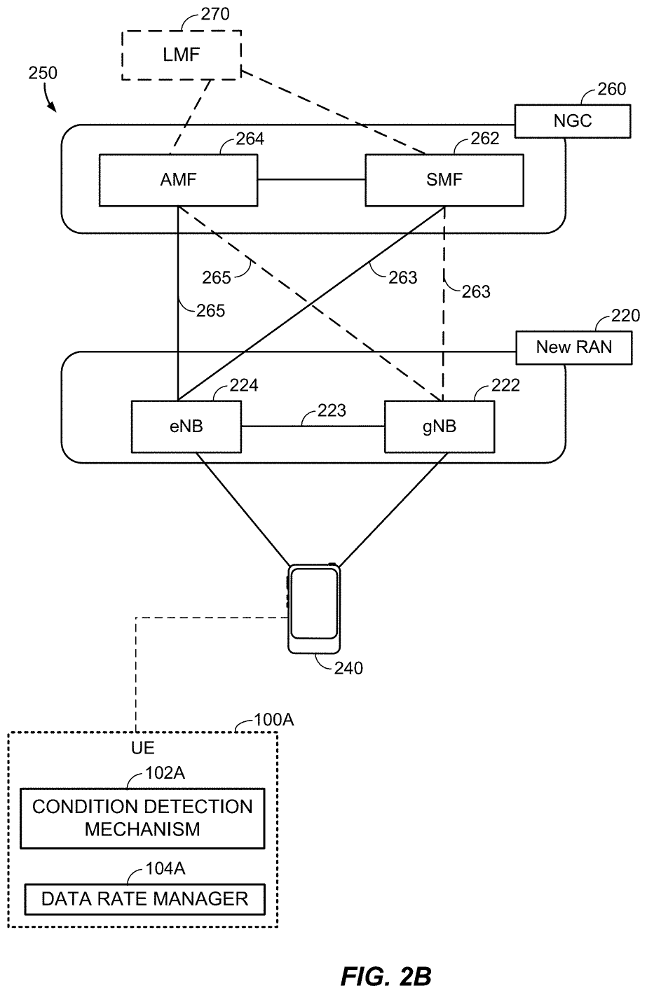

According to various aspects, FIG. 2A illustrates an example wireless network structure 200. For example, an NGC 210 can be viewed functionally as control plane functions 214 (e.g., UE registration, authentication, network access, gateway selection, etc.), and user plane functions 212 (e.g., UE gateway function, access to data networks, Internet protocol (IP) routing, etc.), which operate cooperatively to form the core network. User plane interface (NG-U) 213 and control plane interface (NG-C) 215 connect the gNB 222 to the NGC 210 and specifically to the control plane functions 214 and user plane functions 212. In an additional configuration, an eNB 224 may also be connected to the NGC 210 via NG-C 215 to the control plane functions 214 and NG-U 213 to user plane functions 212. Further, eNB 224 may directly communicate with gNB 222 via a backhaul connection 223. Accordingly, in some configurations, the New RAN 220 may only have one or more gNBs 222, while other configurations include one or more of both eNBs 224 and gNBs 222. Either gNB 222 or eNB 224 may communicate with UEs 240 (e.g., any of the UEs depicted in FIG. 1, such as UEs 104, UE 152, UE 182, UE 190, etc.). Another optional aspect may include a location server 230 that may be in communication with the NGC 210 to provide location assistance for UEs 240. The location server 230 can be implemented as a plurality of structurally separate servers, or alternately may each correspond to a single server. The location server 230 can be configured to support one or more location services for UEs 240 that can connect to the location server 230 via the core network, NGC 210, and/or via the Internet (not illustrated). Further, the location server 230 may be integrated into a component of the core network, or alternatively may be external to the core network.

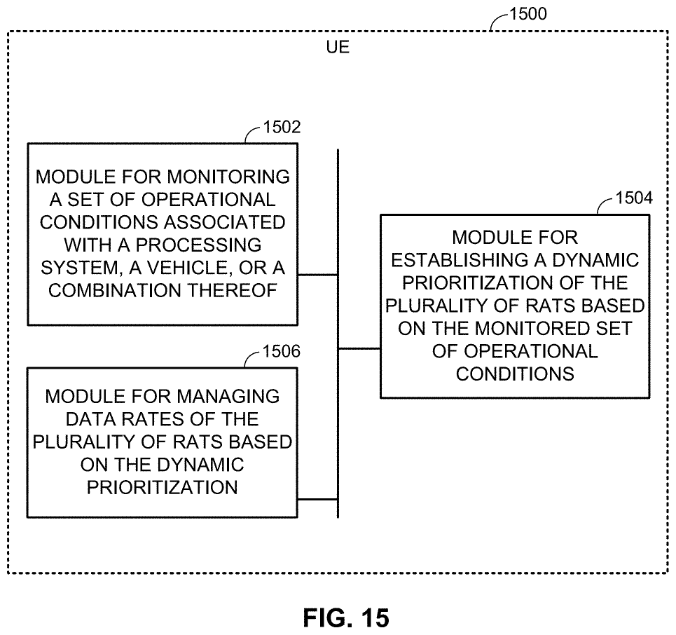

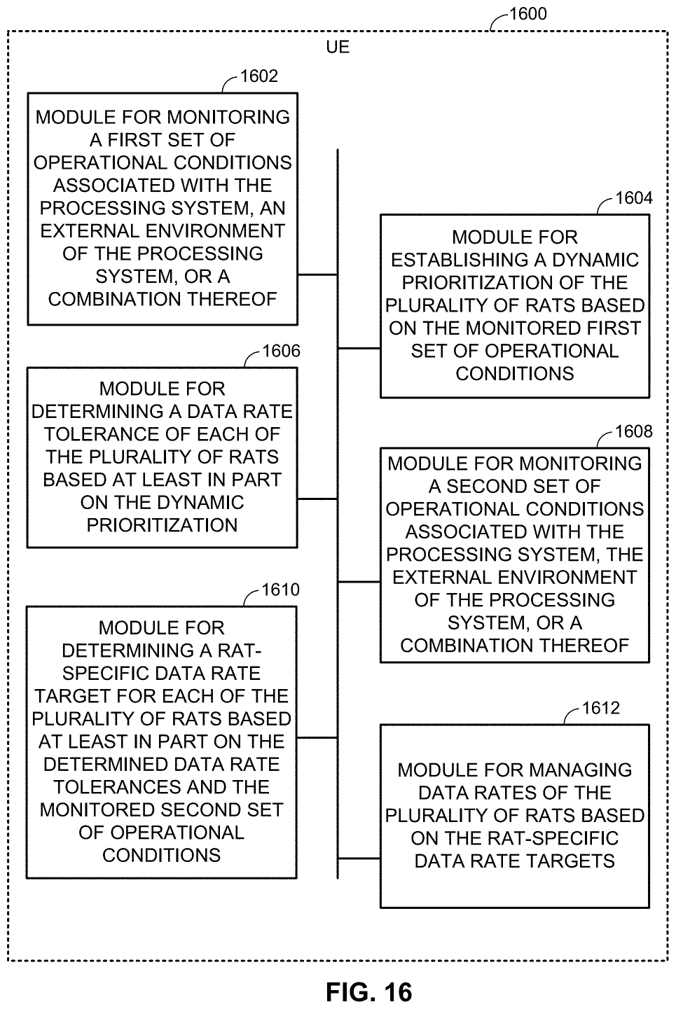

Further illustrated in FIG. 1 is an example UE 100A. The UE 100A includes at least a condition detection mechanism 102A and a data rate manager 104A. As will be described in more detail below, the condition detection mechanism 102A can include one or more sensors and/or monitors to detect various conditions associated with a processing system of the UE and/or a surrounding environment of the UE. In some designs, the UE is associated with (or coupled to) a vehicle, in which case the condition detection mechanism 102A may monitor one or more conditions ‘internal’ to the processing system of the UE (e.g., temperature, processing utilization, application-specific status information, etc.), one or more conditions ‘external’ to the UE (e.g., in-cabin driving events, exterior driving events, etc.), or a combination thereof. As will be described in more detail below, the data rate manager 104A may dynamically control the data rate allocated to various RATs based in part upon the condition(s) detected by the condition detection mechanism 102A. Accordingly, the UE 100A appears in certain FIGS below to emphasize the configurations of various UEs. Moreover, the UE 1500 of FIG. 15 and UE 1600 of FIG. 16 illustrate more detailed implementation examples of the UE 100A in accordance with various aspects.

According to various aspects, FIG. 2B illustrates another example wireless network structure 250. For example, an NGC 260 can be viewed functionally as control plane functions, an access and mobility management function (AMF) 264 and user plane functions, and a session management function (SMF) 262, which operate cooperatively to form the core network. User plane interface 263 and control plane interface 265 connect the eNB 224 to the NGC 260 and specifically to AMF 264 and SMF 262. In an additional configuration, a gNB 222 may also be connected to the NGC 260 via control plane interface 265 to AMF 264 and user plane interface 263 to SMF 262. Further, eNB 224 may directly communicate with gNB 222 via the backhaul connection 223, with or without gNB direct connectivity to the NGC 260. Accordingly, in some configurations, the New RAN 220 may only have one or more gNBs 222, while other configurations include one or more of both eNBs 224 and gNBs 222. Either gNB 222 or eNB 224 may communicate with UEs 240 (e.g., any of the UEs depicted in FIG. 1, such as UEs 104, UE 182, UE 190, etc.). Another optional aspect may include a location management function (LMF) 270, which may be in communication with the NGC 260 to provide location assistance for UEs 240. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 240 that can connect to the LMF 270 via the core network, NGC 260, and/or via the Internet (not illustrated).

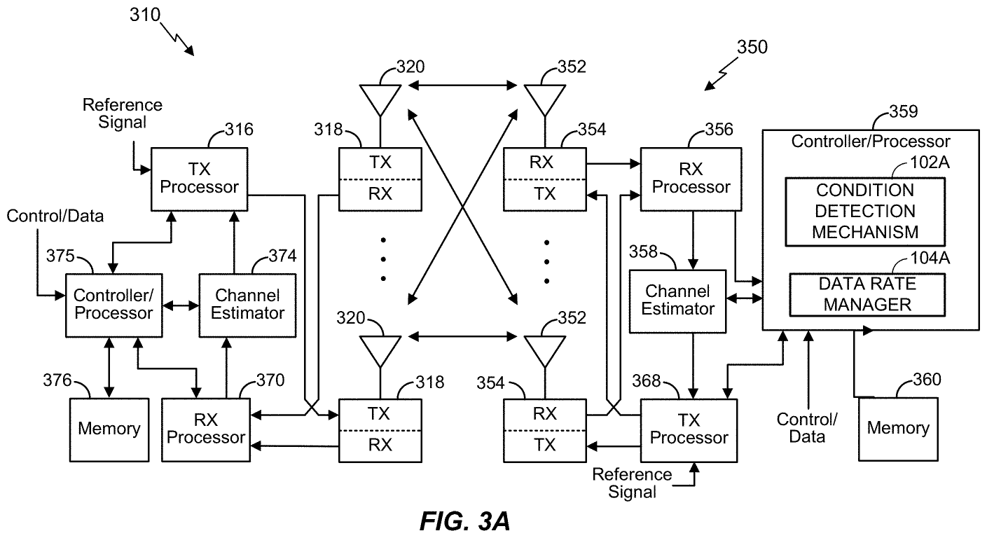

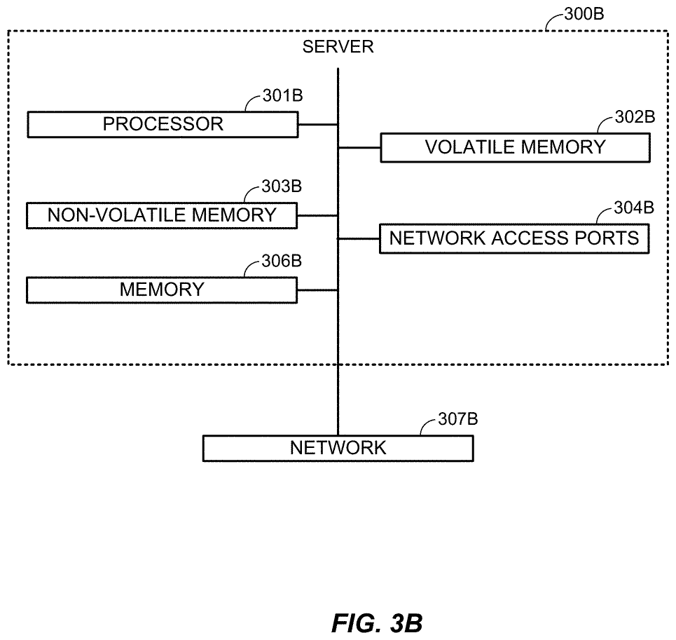

According to various aspects, FIG. 3A illustrates an exemplary base station (BS) 310 (e.g., an eNB, a gNB, a small cell AP, a WLAN AP, etc.) in communication with an exemplary UE 350 (e.g., any of the UEs depicted in FIG. 1, such as UEs 104, UE 152, UE 182, UE 190, etc.) in a wireless network. In the DL, IP packets from the core network (NGC 210/EPC 260) may be provided to a controller/processor 375. The controller/processor 375 implements functionality for a radio resource control (RRC) layer, a packet data convergence protocol (PDCP) layer, a radio link control (RLC) layer, and a medium access control (MAC) layer. The controller/processor 375 provides RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmit (TX) processor 316 and the receive (RX) processor 370 implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency-division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to one or more different antennas 320 via a separate transmitter 318a. Each transmitter 318a may modulate an RF carrier with a respective spatial stream for transmission.

At the UE 350, each receiver 354a receives a signal through its respective antenna 352. Each receiver 354a recovers information modulated onto an RF carrier and provides the information to the RX processor 356. The TX processor 368 and the RX processor 356 implement Layer-1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and de-interleaved to recover the data and control signals that were originally transmitted by the base station 310 on the physical channel. The data and control signals are then provided to the processing system 359, which implements Layer-3 and Layer-2 functionality.

The processing system 359 can be associated with a memory 360 that stores program codes and data. The memory 360 may be referred to as a non-transitory computer-readable medium. In the UL, the processing system 359 provides demultiplexing between transport and logical channels, packet reassembly, deciphering, header decompression, and control signal processing to recover IP packets from the core network. The processing system 359 is also responsible for error detection.

Similar to the functionality described in connection with the DL transmission by the base station 310, the processing system 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARD), priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354b. Each transmitter 354b may modulate an RF carrier with a respective spatial stream for transmission. In an aspect, the transmitters 354b and the receivers 354a may be one or more transceivers, one or more discrete transmitters, one or more discrete receivers, or any combination thereof.

The UL transmission is processed at the base station 310 in a manner similar to that described in connection with the receiver function at the UE 350. Each receiver 318b receives a signal through its respective antenna 320. Each receiver 318b recovers information modulated onto an RF carrier and provides the information to a RX processor 370. In an aspect, the transmitters 318a and the receivers 318b may be one or more transceivers, one or more discrete transmitters, one or more discrete receivers, or any combination thereof.

The processing system 375 can be associated with a memory 376 that stores program codes and data. The memory 376 may be referred to as a non-transitory computer-readable medium. In the UL, the processing system 375 provides demultiplexing between transport and logical channels, packet reassembly, deciphering, header decompression, control signal processing to recover IP packets from the UE 350. IP packets from the processing system 375 may be provided to the core network. The processing system 375 is also responsible for error detection.

FIG. 3B illustrates an exemplary server 300B. In an example, the server 300B may correspond to one example configuration of the location server 230 described above. In FIG. 3B, the server 300B includes a processor 301B coupled to volatile memory 302B and a large capacity nonvolatile memory, such as a disk drive 303B. The server 300B may also include a floppy disc drive, compact disc (CD) or DVD disc drive 306B coupled to the processor 301B. The server 300B may also include network access ports 304B coupled to the processor 301B for establishing data connections with a network 307B, such as a local area network coupled to other broadcast system computers and servers or to the Internet.

In various aspects, UEs are configured to wirelessly communicate over a variety of RATs, such as V2X (e.g., vehicle to infrastructure communication such as cellular V2X or C-V2X, vehicle-to-vehicle communication, etc.), 4G, 5G, Bluetooth, Wi-Fi, a RAT supporting voice calls (e.g., can correspond to one of the other noted RATs, with a data communication context of the RAT being evaluated to determine whether a voice call is currently being supported), and so on. In some designs, such UEs may be provisioned with multiple subscriber identity modules (SIMs) to support two or more of the RATs, although single SIM designs may also be used. Multi-RAT UEs generally consume more power and utilize more processing resources when more RATs are being concurrently utilized at higher data rates. For example, for UEs associated with (e.g., integrated into, couple to, etc.) vehicles, multi-RAT concurrency scenarios are fairly common.

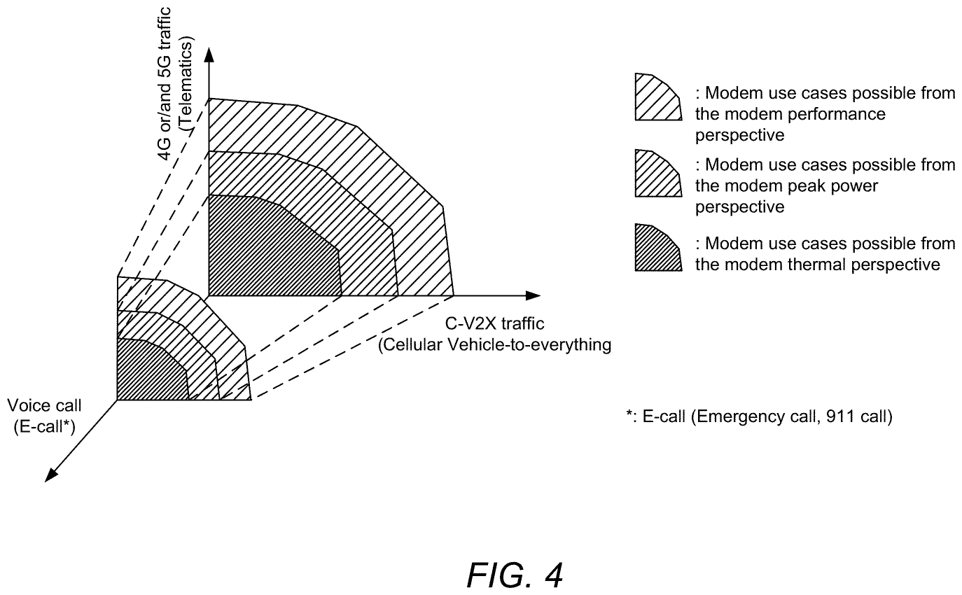

FIG. 4 illustrates a conceptual concurrency scenario in accordance with an aspect of the disclosure. In particular, the concurrency scenario of FIG. 4 depicts modem use cases as a function of data rates for 4G/5G (y-axis), C-V2X (x-axis) and a high-priority (e.g., emergency, or 911) voice call (z-axis). In particular, the modem use cases depicted in FIG. 4 is shown with respect to scenarios where modem usage is possible from a thermal perspective (e.g., where a temperature of the modem or processing system is within acceptable levels), a peak power perspective (e.g., where a power consumption of the modem or processing system is within acceptable levels), and a performance perspective (e.g., where a performance level of the modem or processing system is within acceptable levels). As will be appreciated, the modem will become unusable at some point as data rates on the various RATs exceed various constraints (in this case, temperature, peak power, or performance).

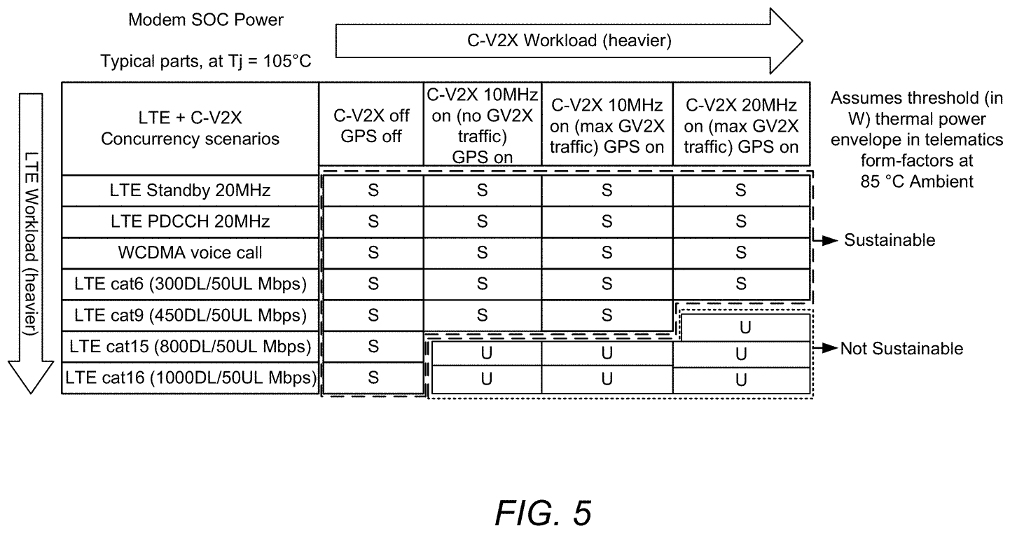

FIG. 5 illustrates a modem-specific example of the conceptual concurrency scenario of FIG. 4 in accordance with an aspect of the disclosure. In particular, FIG. 5 depicts concurrency scenarios for LTE and C-V2X for a particular modem system on chip (SOC). In FIG. 5, LTE categories 6, 9, 15 and 16 refer to maximum bandwidths in uplink and downlink directions. As shown in FIG. 5, higher processing workloads are associated with higher power consumption and likewise higher temperatures. For certain applications, a power consumption of approximately 1.25 W may used as a limit or cap so as to maintain a temperature of the processing system (e.g., the modem processing system or SOC) below a threshold temperature, such as 85° C., as depicted in FIG. 5. In FIG. 5, scenarios associated with a high concurrent workload for both LTE and C-V2X are shown as exceeding the above-noted threshold such that the associated power consumption and/or temperature is unsustainable. Specifically, scenarios with sustainable power consumption and/or temperature are denoted with “S”, while scenarios with unsustainable power consumption and/or temperature are denoted with “U”. In FIG. 5, a threshold (in W) thermal power envelope is assumed, whereby operation of the modem system is deemed sustainable (S) if operating below the threshold thermal power envelope and operation of the modem system is deemed unsustainable (U) if operating below the threshold thermal power envelope.

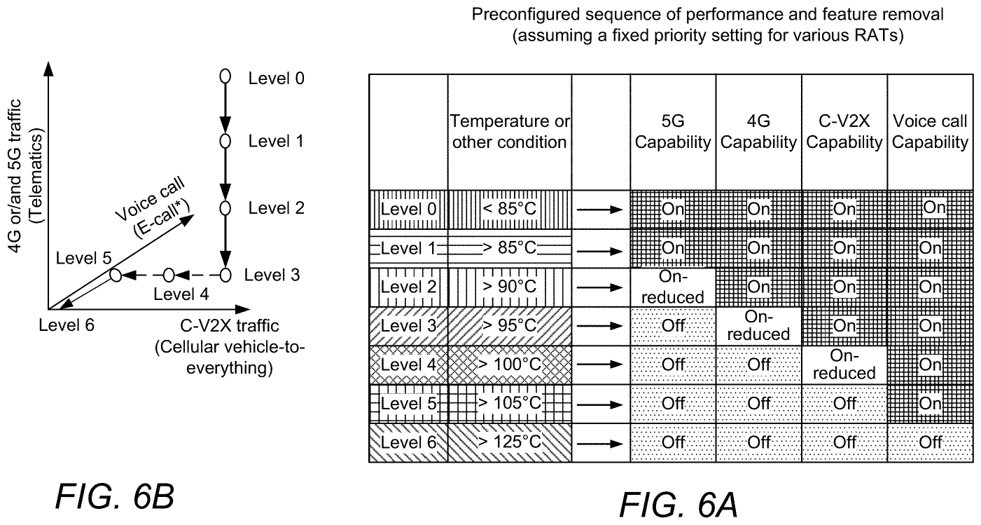

Because not all RATs can be maxed out in terms of workload concurrently, certain RATs (i.e., lower priority RATs) may need to be limited or restricted in terms of their workload to ensure stable and sustainable performance of the modem in some multi-RAT concurrency scenarios. FIGS. 6A-6B illustrates a RAT workload reduction algorithm in accordance with an aspect of the disclosure. In particular, the RAT workload reduction algorithm is implemented with respect to a modem processing system (e.g., an SOC) of a UE that is associated with a vehicle.

Referring to FIGS. 6A-6B, the UE is preconfigured with a RAT priority ranking, as shown in Table 1 as follows:

TABLE 1
Predetermined RAT Prioritization

| | Priority |
|---|---|
| RAT Type | (4 highest, 1 lowest) |
| 5G | 1 |
| 4G | 2 |
| C-V2X | 3 |
| Emergency Voice Call RAT | 4 |

So, in Table 1, if 5G is supporting the emergency voice call, then the 5G priority is (temporarily) set to 4 until the emergency voice call is over, at which point the 5G priority returns to 1. As shown in FIG. 6A, the RATs with higher priority levels maintain their functionality at higher temperatures (e.g., modem core temperatures) as compared to lower priority RATs. In particular, 7 distinct RAT functionality levels (Levels 0-6) are depicted for various SOC temperature conditions. FIG. 6B depicts the impact to data rates to the various RATs at each of Levels 0-6.

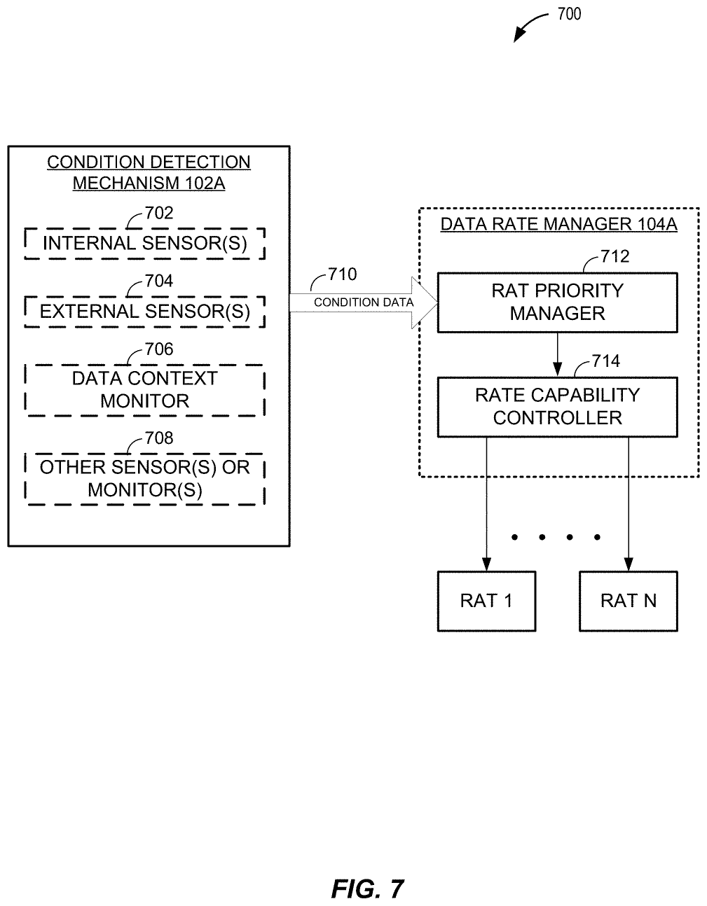

FIG. 7 illustrates a multi-RAT UE 700 in accordance with an aspect of the disclosure. In an example UE 700 may correspond to an example implementation of UE 100A.

Referring to FIG. 7, the condition detection mechanism 102A includes one or more internal sensors, 702, one or more external sensors 704, a data context monitor 706, one or more other sensors or monitors 708, or any combination thereof.

In an example, the internal sensor(s) 702 may be configured to monitor one or more internal conditions of a processing system (e.g., modem processing system, a SOC, etc.) of the UE itself, including but not limited to any combination of the following:
a utilization level of the processing system,
an operating frequency of the processing system,
an idle duration level of the processing system,
a power consumption level of the processing system,
an amount of memory read traffic, write traffic, or a combination thereof,
a temperature of a component (e.g., modem processor, SOC, etc.) of the processing system.

In a further example, the external sensor(s) 704 may be configured to monitor an external environment of the UE itself. In a vehicle-specific context, the external environment conditions monitored by the external sensor(s) 704 may include one or more in-cabin driving events of the vehicle (e.g., driver is texting, driver fell asleep, driver heartrate, vehicle is operating in human-control mode, vehicle is operating in autonomous mode, etc.), one or more exterior driving events of the vehicle (e.g., road conditions such as weather, etc., whether the vehicle is driving or parked, whether the vehicle is driving in a city or rural area, etc.), or any combination thereof.

In a further example, the data context monitor 706 may be configured to monitor one or more application-specific contextual conditions associated with the processing system of the UE, including but not limited to a RAT-related status of one or more applications configured for execution by the processing system (e.g., which applications are transporting data via any of the RATs, whether any of the RATs are supporting a voice call, etc.), one or more custom settings set by a third party such as an original equipment manufacturer (OEM) settings defined by an OEM of the processing system (e.g., some OEMs may specify various rules that may impact RAT priority, etc.), or any combination thereof. In one example, the data context monitor 706 may determine whether data being transported over one RAT is higher in terms of priority than data being transported over another RAT (e.g., RAT #1 is supporting a high-priority Wi-Fi VoIP call, while RAT #2 is performing a low-priority file transfer).

Non-limiting examples of custom settings (e.g., OEM settings) pertaining to application-specific contextual conditions include RAT-specific weighting or bias value to allocate one or more RATs a higher or lower priority. For example, if a vehicle is designed to use 4G/5G for non-voice data communications (e.g., web browsing, navigation, video streaming, etc.), the vehicle maker (or OEM) may allocate a higher priority (via the weighting or bias value) to C-V2X (e.g., to ensure that C-V2X does not receive any data rate reductions). In another example, an OEM may design a vehicle with reliance upon 5G to support a self-driving feature, such that the OEM may allocate a higher priority (via the weighting or bias value) to 5G (e.g., to ensure that 5G does not receive any data rate reductions, possibly only while the vehicle is operating in self-driving mode).

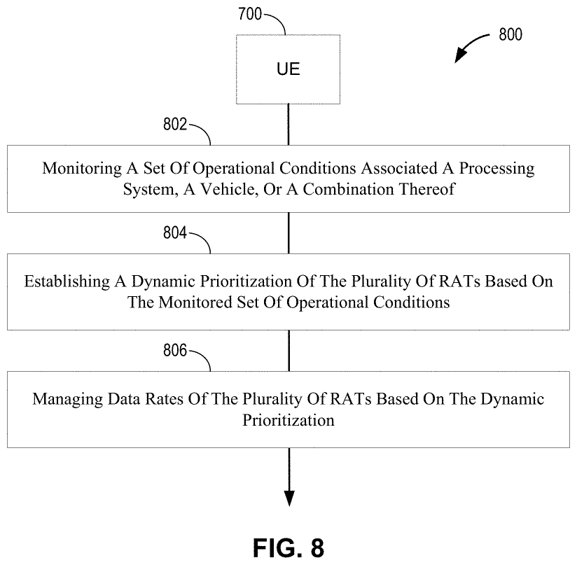

As shown in FIG. 7, the condition detection mechanism 102A may provide condition data 710 to a RAT priority manager 712 of the data rate manager 104A. The condition data 710 may be provided continuously, periodically, or in an event-triggered manner. The condition data 710 may comprise the ‘raw’ data monitored or measured (e.g., a measured temperature or power level of a modem processor) by the various components 702-708 of the condition detection mechanism 102A, or alternatively may provide processed data (e.g., descriptive of an event that has occurred, such as an in-cabin driving event or an exterior driving event). The RAT priority manager 712 receives the condition data 710 and dynamically adjusts the priorities of the RATs accordingly, as described below with respect to FIG. 8 in more detail. A rate capability controller 714 may receive the dynamically adjusted priorities of the RATs from the RAT priority manager 712, and may adjust the data rates of the RATs (denoted in FIG. 7 as RATs 1 . . . N) accordingly.

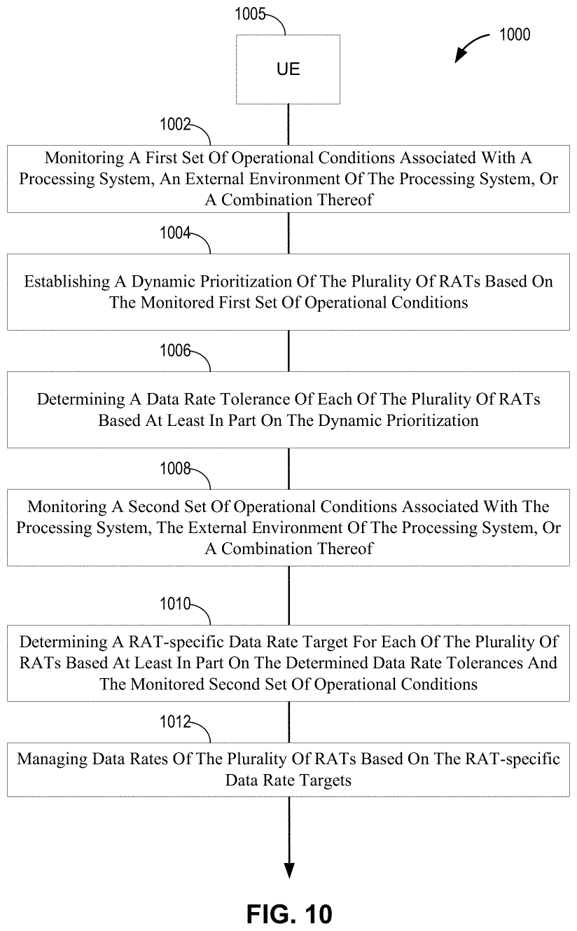

Historically, multi-RAT communications associated with vehicles have been fairly limited. However, more recently, multi-RAT vehicular communications are becoming more prevalent (e.g., as vehicles are being designed for semi-autonomous and/or fully autonomous modes of operation). Hence, tuning (e.g., optimizing) data rates on a RAT-by-RAT basis has not been prioritized with respect to vehicular communications. Various aspects of the disclosure as will be described below with respect to FIGS. 8, 10, etc. provide various technical advantages particularly for multi-RAT communications involving vehicles (e.g., C-V2X, etc.), including but not limited to a more efficient RAT-specific management of data rates (e.g., based on dynamic or static RAT priorities, situational conditions, etc.).

FIG. 8 illustrates a data rate management procedure 800 in accordance with an aspect of the disclosure. In an example, the process 800 of FIG. 8 is performed by UE 700, which may correspond to any of UEs 100A, 240, 350, etc.

Referring to FIG. 8, at block 802, the UE 700 (e.g., condition detection mechanism 102A) monitors a set of operational conditions associated with the processing system, a vehicle, or a combination thereof. In an example, the set of operational conditions includes one or more in-cabin driving events of the vehicle, one or more exterior driving events of the vehicle, a RAT-related status of one or more applications configured for execution by the processing system, one or more custom settings (e.g., OEM settings defined by an OEM of the processing system), or any combination thereof. At block 804, the UE 700 (e.g., RAT priority manager 712 of data rate manager 104A) establishes a dynamic prioritization of the plurality of RATs based on the monitored set of operational conditions. At block 806, the UE 700 (e.g., rate capability controller 714 of data rate manager 104A) manages data rates of the plurality of RATs based on the dynamic prioritization.

In one example, at block 806, the RAT workload reduction algorithm depicted in FIGS. 6A-6B can be leveraged based on the dynamic RAT prioritization as opposed to using a default or preconfigured RAT priority scheme. In this case, a dynamic RAT prioritization corresponding to Table 1 (above) would result in the RAT workload reduction algorithm depicted in FIGS. 6A-6B. However, now assume that the user hangs up the emergency voice call (e.g., 911 call) such that the RAT previously supporting the emergency voice call is no longer highly prioritized, resulting in a dynamic RAT prioritization as follows:

TABLE 2
Dynamic RAT Prioritization

| | Priority |
|---|---|
| RAT Type | (4 highest, 1 lowest) |
| 5G | 2 |
| 4G | 3 |
| C-V2X | 4 |

As shown in Table 2, the emergency voice call RAT is removed because the voice call has ended (e.g., if 5G was supporting the emergency voice call, then the priority allocated to 5G is reduced, etc.). In this case, the Table depicted in FIG. 6A may likewise be updated as follows:

TABLE 3
RAT Workload Reduction Algorithm

| Level | Temp. | | 5G | 4G | C-V2X |
|---|---|---|---|---|---|
| Level 0 | <85° | C. | On | On | On |
| Level 1 | >85° | C. | On | On | On |
| Level 2 | >90° | C. | On | On | On |
| Level 3 | >95° | C. | On-Reduced | On | On |
| Level 4 | >100° | C. | Off | On-Reduced | On |
| Level 5 | >105° | C. | Off | Off | On-Reduced |
| Level 6 | >125° | C. | Off | Off | Off |

Accordingly, in some designs, dynamic RAT prioritization can be used so as to supplement conventional RAT workload reduction algorithms.

Referring to FIG. 8, it will be appreciated that changes to the monitored set of operational conditions from block 802 can result in changes to the RAT-specific data rates at block 806. For example, the UE 700 can detect a change in the monitored set of operational conditions from block 802, which triggers an update to the dynamic prioritization from block 804 in accordance with the detected change, whereby the managing at block 806 then manages the data rates based on the updated dynamic prioritization.

In some designs, voice calls can be treated differently from other data communications. For example, non-voice data rates can be reduced to various degrees in other data communications (e.g., GPS, file downloads, streaming media, etc.) in accordance with the process 800 of FIG. 8, while any RAT supporting an active voice call is maintained at 100% (no data rate reduction). In such designs, an operational condition indicative of whether or not a voice call is active functions to override any other considerations, although once the voice call is over then other parameters can be considered to dynamically allocate priority to an associated RAT.

It will be appreciated that other operational conditions may also trigger temporary (or dynamic) updates to RAT priority. For example, assume that 4G or 5G is relied upon to support a self-driving mode of an associated vehicle. In this case, 4G or 5G may be allocated a higher priority while the self-driving mode of the vehicle is enabled, and a lower or ‘normal’ priority when the self-driving mode of the vehicle is disabled.

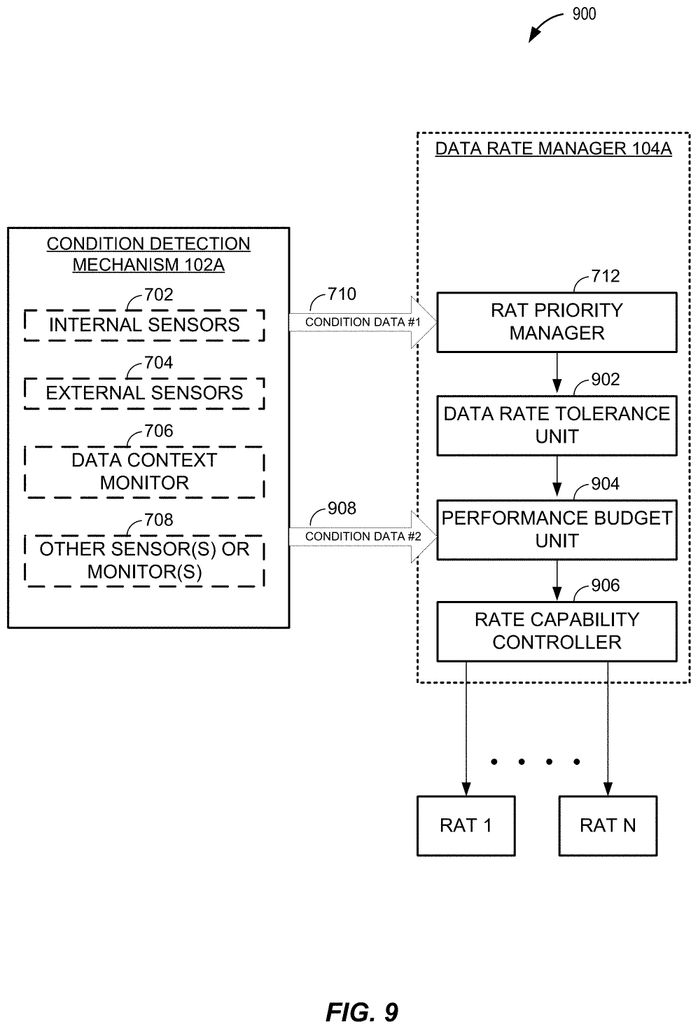

FIG. 9 illustrates a multi-RAT UE 900 in accordance with an aspect of the disclosure. In an example UE 700 may correspond to another example implementation of UE 100A.

Referring to FIG. 9, the condition detection mechanism 102A may be configured similarly to the condition detection mechanism 102A described above with respect to FIG. 7 in some aspects. Accordingly, the condition detection mechanism 102A outputs condition data to the RAT priority manager 712, similar to FIG. 7. However, instead of outputting condition data to the RAT priority manager alone, condition data (which may be the same or different) is also output to a performance budget unit as will be described below in more detail.

Referring to FIG. 9, the data rate manager 104A includes the RAT priority manager 712 similar to FIG. 7, and further includes a data rate tolerance unit 902, a performance budget unit 904, and a rate capability controller 906. The rate capability controller 906 differs from the rate capability controller 714 of FIG. 7, as the rate capability controller 906 does not control data rates based strictly upon the dynamic RAT prioritizations. In FIG. 9, the performance budget unit 904 receives condition data 908 from the condition detection mechanism 102A, which may be distinct from the condition data 710 (although in some designs the respective condition data 710 and 908 may overlap in part). The functionality of the components 904-906 is described below in more detail with respect to FIG. 10.

FIG. 10 illustrates a data rate management procedure 1000 in accordance with an aspect of the disclosure. In an example, the process 1000 of FIG. 10 is performed by UE 900, which may correspond to any of UEs 100A, 240, 350, etc.

Referring to FIG. 10, at block 1002, the UE 700 (e.g., condition detection mechanism 102A) a first set of operational conditions associated with the processing system, an external environment of the processing system, or a combination thereof. Unlike block 802 of FIG. 8, the external environment of the processing system does not necessarily correspond to a vehicle, although such an implementation is possible. In an example, the first set of operational conditions may include a RAT-related status of one or more applications configured for execution by the processing system, one or more custom settings (e.g., OEM settings defined by an OEM of the processing system), or any combination thereof. If the external environment of the processing system corresponding to a vehicle environment (e.g., for a vehicle-integrated or vehicle-coupled UE), the first set of operational conditions may also include one or more in-cabin driving events of the vehicle and/or one or more exterior driving events of the vehicle. At block 1004, the UE 700 (e.g., RAT priority manager 712) establishes a dynamic prioritization of the plurality of RATs based on the monitored first set of operational conditions.

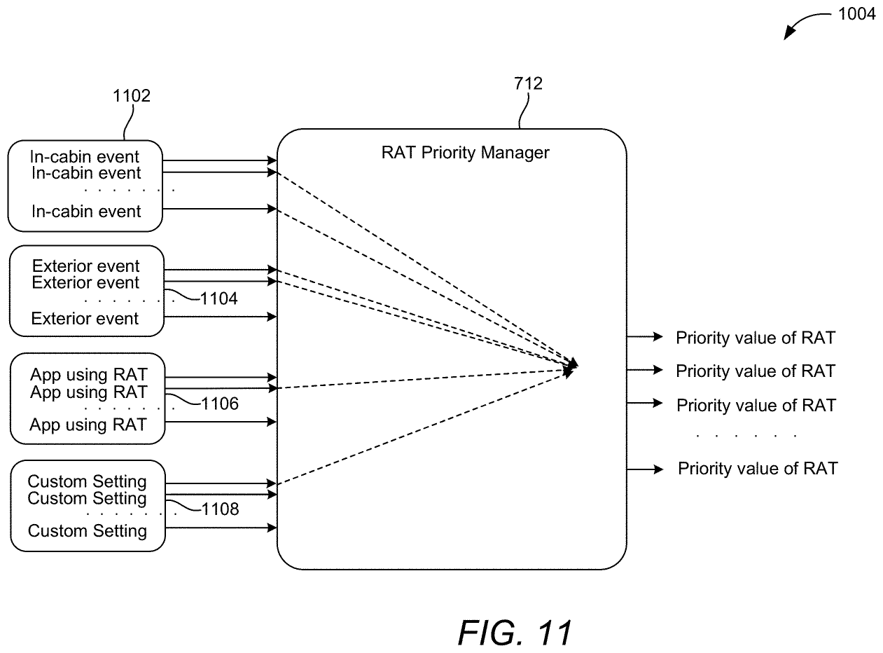

FIG. 11 illustrates a vehicle-specific implementation example of block 1004 in accordance with an aspect of the disclosure. In FIG. 11, the first set of operational conditions includes one or more in-cabin events 1102 (e.g., driver asleep, driver texting, driver heart-rate, etc.), one or more exterior events 1104 (e.g., events that occur outside the vehicle, such as weather conditions, traffic conditions, etc.), indications 1106 of which applications are using which RATs, and custom settings 1108 (e.g., OEM-defined settings). These operational conditions are provided as inputs to the RAT priority manager 712, which then outputs priority values of RATs 1 . . . M using one or more RAT prioritization algorithms (e.g., weighted sums, condition statements, Neural network, etc.).

Returning to FIG. 10, at block 1006, the UE 900 (e.g., data rate tolerance unit 902) determines a data rate tolerance of each of the plurality of RATs based at least in part on the dynamic prioritization. In an example, the data rate tolerance of each of the plurality of RATs corresponds to a degree of data rate reduction over the RAT that can be tolerated while maintaining a threshold RAT-specific user experience level, which is modeled as a function using the dynamic prioritization as an input. For instance, some RATs may experience significant degradation to user experience level in response to only a slight reduction to date rate, while other RATs experience only a slight degradation to user experience level in response to a significant reduction to data rate.

In some designs, voice calls can be treated differently from other data communications. For example, non-voice data rates can be reduced to various degrees in other data communications (e.g., GPS, file downloads, streaming media, etc.) in accordance with the process 1000 of FIG. 10, while any RAT supporting an active voice call is maintained at 100% (no data rate reduction). In such designs, an operational condition indicative of whether or not a voice call is active functions to override any other considerations, although once the voice call is over then other parameters can be considered to dynamically allocate priority to an associated RAT.

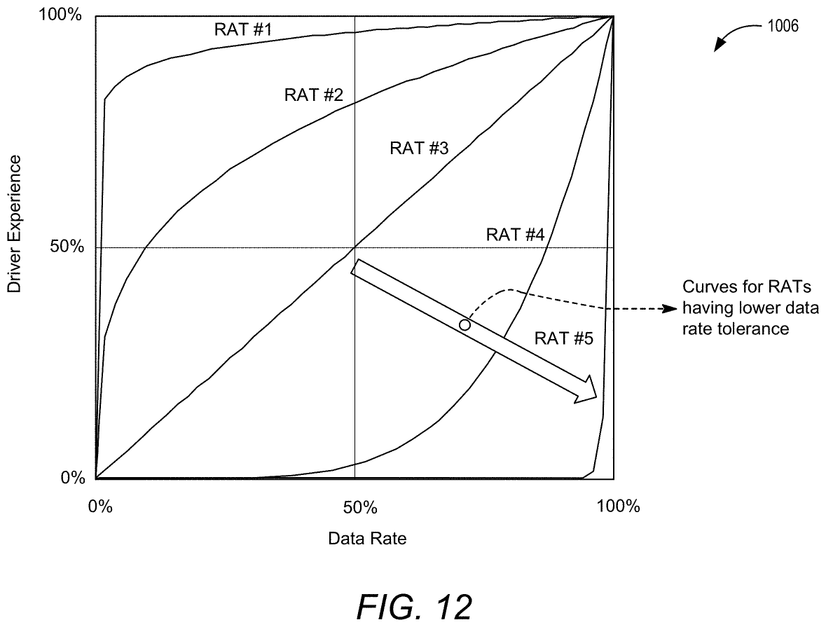

FIG. 12 illustrates an example implementation of block 1006 in accordance with an aspect of the disclosure. Referring to FIG. 12, a curve 1200 is depicted which describes the relationship between data rate of a RAT and ‘driver experience’. As used herein, driver experience refers to the driver's perception of the usefulness of a particular RAT at particular data rates. For non-vehicle implementations, driver experience can be referred to more broadly as user experience. As shown in the curve 1200 of FIG. 12, RATs #1, #2, #4 and #5 have a non-linear relationship between driver experience and data rate (e.g., a diminishing return after a certain data rate), while RAT #3 has a linear relationship between driver experience and data rate. In some designs, the driver experience of a total system is determined by the lowest driver experience value of concurrent RATs. In an example, different RATs may have different curves depending on various factors (e.g., which applications are currently transporting data over which RATs, whether a voice call is active on any particular RAT, etc., driving situations such as whether turn-by-turn navigation is active, etc.).

Referring to FIG. 12, in an example, parameters may be defined as follows:
Pᵢ: Data Rate of RAT i (e.g., actual data rate or maximum data rate)
Cᵢ: Criticality (Priority) of RAT i (e.g., as dynamically determined by the RAT priority manager 712)
Xᵢ: Driver Experience of RAT i
X: Driver Experience of the overall communication system (all RATs)

In this case, the driver experience can be defined as a function of P and C, e.g., Xᵢ=functionᵢ(Pᵢ, Cᵢ) and X=min (Xᵢ for all i). One example of functionᵢ is Xᵢ=Pᵢ^{(1/Ci)}.

Returning to FIG. 10, at block 1008, the UE 900 (e.g., condition detection mechanism 102A) monitors a second set of operational conditions associated with the processing system, the external environment of the processing system, or a combination thereof.

In an example, the second set of operational conditions includes one or more performance metrics associated with the processing system, information characterizing a communicative status of the processing system, information characterizing an environment of the processing system, or any combination thereof. For example, non-limiting examples of the one or more performance metrics associated with the processing system may include any of:
a utilization level of the processing system,
an operating frequency of the processing system,
an idle duration level of the processing system,
a power consumption level of the processing system, or
any combination thereof.

In some designs, non-limiting examples of the information characterizing the environment of the processing system includes an amount of memory read traffic, write traffic, or a combination thereof. In some designs, non-limiting examples of the information characterizing the environment of the processing system includes a temperature of a component (e.g., SOC, modem processor, etc.) of the processing system. In some designs, the first and second sets of operational conditions can be different in some designs, while the first and second sets of operational conditions can overlap at least in part in other designs. At block 1010, the UE 900 (e.g., performance budget unit 904) determines a RAT-specific data rate target for each of the plurality of RATs based at least in part on the determined data rate tolerances and the monitored second set of operational conditions.

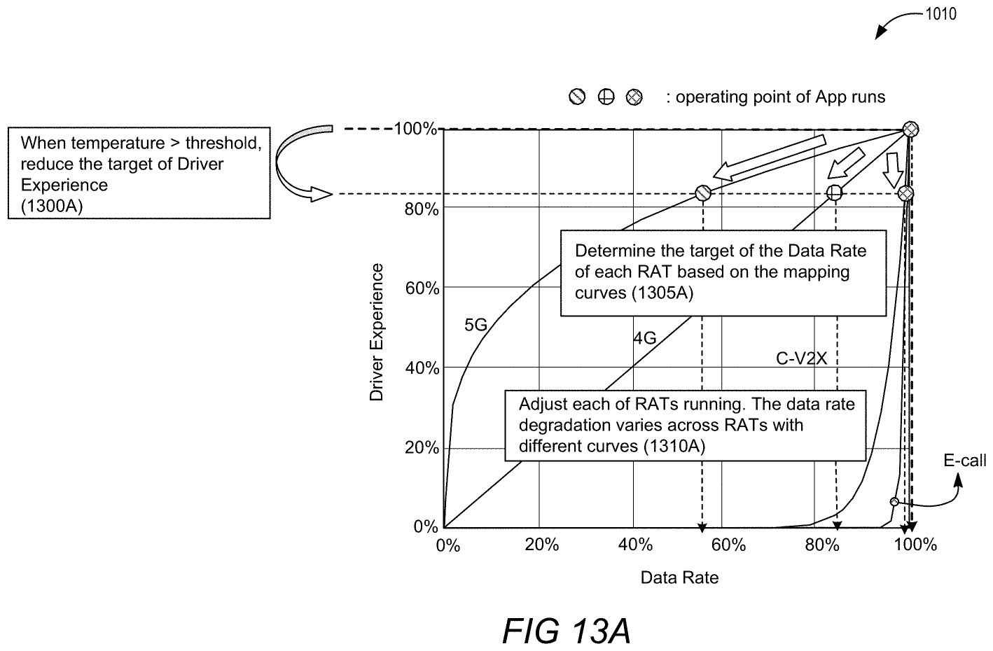

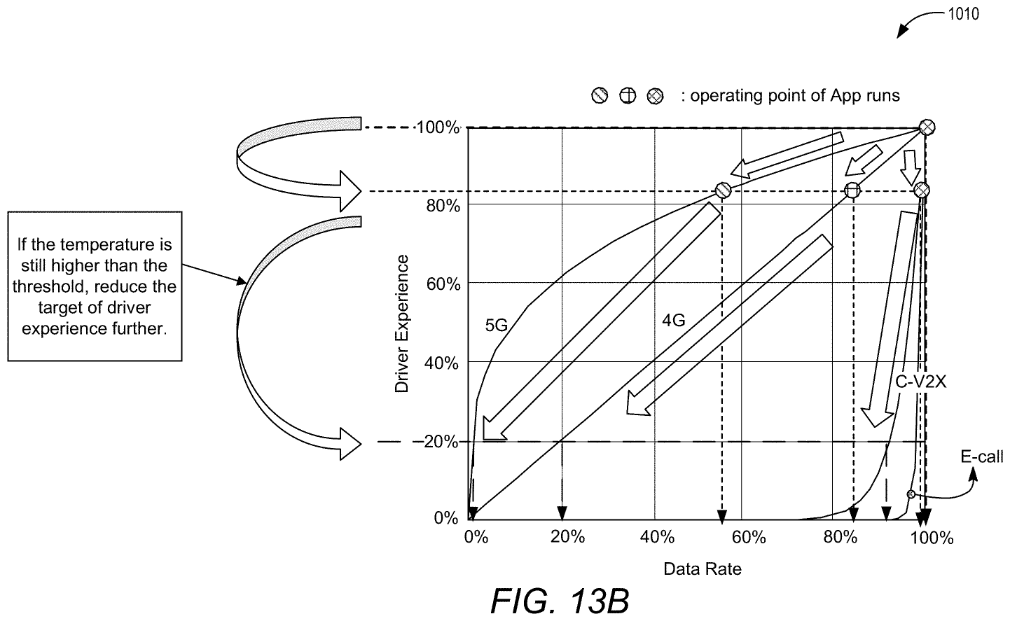

FIGS. 13A-13B illustrates an example implementation of block 1010 in accordance with an aspect of the disclosure. In particular, FIGS. 13A-13B illustrate an example whereby the second set of operational conditions includes temperature (e.g., temperature of a component of the UE processing system, such as a modem of the UE processing system) with respect to RATs comprising 4G, 5G, C-V2X and an E-call. At block 1300A, when the monitored temperature rises above a threshold, a driver experience target is used. In this specific example, the driver experience target is reduced from 100% to 80%. At block 1310A, a target data rate is determined for each RAT based on the mapping curves. At block 1315A, the performance budget unit 904 provides an instruction to the rate capability controller 906 for the respective data rates to be adjusted in accordance with the rates determined at block 1310A. FIG. 13B illustrates a further example implementation of block 1010 in accordance with an aspect of the disclosure. In FIG. 13B, the temperature of the processing system component rises further, and the driver experience target is reduced from 80% to 20%, with the corresponding RAT-specific data rates being reduced accordingly.

Returning to FIG. 10, at block 1012, the UE 900 (e.g., rate capability controller 906) manages data rates of the plurality of RATs based on the RAT-specific data rate targets. In an example, there are various ways in which the data rate can be controlled by the rate capability controller 906 at block 1012. One example described above is based upon the RAT workload reduction algorithm described above with respect to FIGS. 6A-8. Other example mechanisms for controlling the RAT-specific data rates includes reducing the number of carriers and/or reducing a carrier aggregation capability or a category capability (e.g., for 4G or 5G RATs), adjusting a packet filtering parameter based on a ProSe Per-Packet Priority (PPPP) field in a control channel (e.g., for V2X RATs), etc.

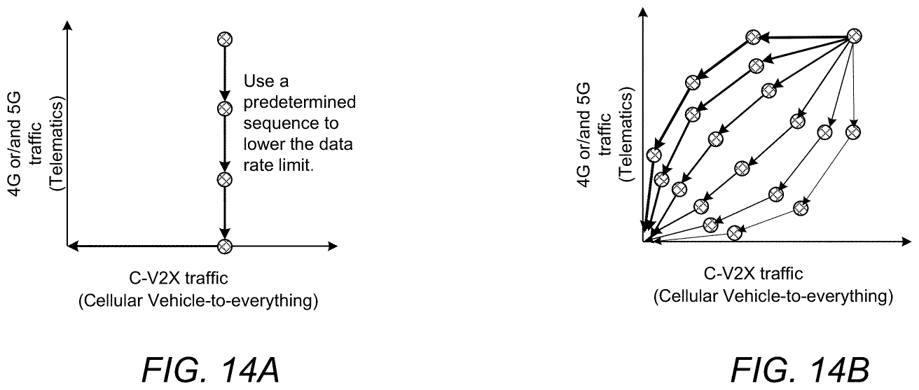

FIGS. 14A-14B contrast a preconfigured data rate limiting approach (e.g., as illustrated in FIGS. 6A-6B) compared with a dynamic data rate limiting approach (e.g., as illustrated in one or more of FIGS. 7-13B) with respect to particular RATs (e.g., 4G/5G and C-V2X) in accordance to aspects of the disclosure. As shown, the data rate limiting approach based on dynamic RAT prioritization (FIG. 14B) is more balanced between RATs compared to the preconfigured data rate limiting approach based on static RAT prioritization (FIG. 14A) whereby RATs are simply turned off one-by-one in a fixed order. The various curves depicted in FIG. 14B demonstrate that the particular balance of data rate adjustments can be fine-tuned across the RATs in accordance with various aspects of the disclosure.

Referring to FIG. 10, it will be appreciated that changes to the first or second sets of operational conditions from blocks 1002 or 1008 can result in changes to the RAT-specific data rates at block 1012. For example, the UE 900 can detect a change in the monitored first set of operational conditions from block 1002, which triggers an update to the dynamic prioritization from block 1004 in accordance with the detected change, which in turn triggers an update to the data rate tolerances from block 1006 based on the updated dynamic prioritization, which in turn triggers an update to the RAT-specific data rate targets from block 1010 based on the updated data rate tolerances, whereby the managing at block 1012 then manages the data rates based on the updated RAT-specific data rate targets. In a further example, the UE 900 can detect a change in the monitored second set of operational conditions from block 1008, which triggers an update to the RAT-specific data rate targets from bock 1010 based on the detected change, whereby the managing at block 1012 then manages the data rates based on the updated RAT-specific data rate targets.

FIG. 15 illustrates an example UE 1500 for implementing the process 800 of FIG. 8 represented as a series of interrelated functional modules in accordance with an aspect of the disclosure. In the illustrated example, the UE 1500 includes a module for monitoring 1502, a module for establishing 1504, and a module for managing 1506.

The module for monitoring 1502 may be configured to monitor a set of operational conditions associated with a processing system, a vehicle, or a combination thereof (e.g., block 802 of FIG. 8). The module for establishing 1504 may be configured to establish a dynamic prioritization of the plurality of RATs based on the monitored set of operational conditions (e.g., block 804 of FIG. 8). The module for managing 1506 may be configured to manage data rates of the plurality of RATs based on the dynamic prioritization (e.g., block 806 of FIG. 8).

FIG. 16 illustrates an example UE 1600 for implementing the process 1000 of FIG. 10 represented as a series of interrelated functional modules in accordance with an aspect of the disclosure. In the illustrated example, the UE 1600 includes a module for monitoring 1602, a module for establishing 1604, a module for determining 1606, a module for monitoring 1608, a module for determining 1610 and a module for managing 1612.

The module for monitoring 1602 may be configured to monitor a first set of operational conditions associated with a processing system, an external environment of the processing system, or a combination thereof (e.g., block 1002 of FIG. 10). The module for establishing 1604 may be configured to establish a dynamic prioritization of the plurality of RATs based on the monitored first set of operational conditions (e.g., block 1004 of FIG. 10). The module for determining 1606 may be configured to determine a data rate tolerance of each of the plurality of RATs based at least in part on the dynamic prioritization (e.g., block 1006 of FIG. 10). The module for monitoring 1608 may be configured to monitor a second set of operational conditions associated with the processing system, the external environment of the processing system, or a combination thereof (e.g., block 1008 of FIG. 10). The module for determining 1610 may be configured to determine a RAT-specific data rate target for each of the plurality of RATs based at least in part on the determined data rate tolerances and the monitored second set of operational conditions (e.g., block 1010 of FIG. 10). The module for managing 1612 may be configured to manage data rates of the plurality of RATs based on the RAT-specific data rate targets (e.g., block 1012 of FIG. 10).

The following provides an overview of examples of the present disclosure:

### Example 1

A method of operating a processing system configured to manage communications in accordance with a plurality of radio access technologies (RATs), comprising: monitoring a first set of operational conditions associated with the processing system, an external environment of the processing system, or a combination thereof; establishing a dynamic prioritization of the plurality of RATs based on the monitored first set of operational conditions; determining a data rate tolerance of each of the plurality of RATs based at least in part on the dynamic prioritization; monitoring a second set of operational conditions associated with the processing system, the external environment of the processing system, or a combination thereof; determining a RAT-specific data rate target for each of the plurality of RATs based at least in part on the determined data rate tolerances and the monitored second set of operational conditions; and managing data rates of the plurality of RATs based on the RAT-specific data rate targets.

### Example 2

The method of Example 1, wherein the first set of operational conditions includes: a RAT-related status of one or more applications configured for execution by the processing system, one or more custom settings defined by a third party, or any combination thereof.

### Example 3

The method of Example 1 or 2, wherein the processing system is associated with a vehicle, and wherein the plurality of RATs comprises cellular vehicle-to-everything (C-V2X).

### Example 4

The method of Example 3, wherein the first set of operational conditions includes: one or more in-cabin driving events of the vehicle, one or more exterior driving events of the vehicle, a RAT-related status of one or more applications configured for execution by the processing system, one or more custom settings defined by a third party, or any combination thereof.

### Example 5

The method of any one of Examples 1 through 4, wherein the second set of operational conditions includes: one or more performance metrics associated with the processing system, information characterizing a communicative status of the processing system, information characterizing an environment of the processing system, or any combination thereof.

### Example 6

The method of Example 5, wherein the one or more performance metrics include: a utilization level of the processing system, an operating frequency of the processing system, an idle duration level of the processing system, a power consumption level of the processing system, or any combination thereof.

### Example 7

The method of Example 5 or 6, wherein the information characterizing the environment of the processing system includes an amount of memory read traffic, write traffic, or a combination thereof.

### Example 8

The method of Example 5 or 6 or 7, wherein the information characterizing the environment of the processing system includes a temperature of a component of the processing system.

### Example 9

The method of any one of Examples 1 through 8, wherein the first and second sets of operational conditions are different.

### Example 10

The method of any one of Examples 1 through 10, wherein the data rate tolerance of each of the plurality of RATs corresponds to a degree of data rate reduction over the RAT that can be tolerated while maintaining a threshold RAT-specific user experience level, which is modeled as a function using the dynamic prioritization as an input.

### Example 11

The method of any one of Examples 1 through 10, further comprising: detecting a change in the monitored first set of operational conditions; updating the dynamic prioritization in accordance with the detected change; updating the data rate tolerances based on the updated dynamic prioritization; and updating the RAT-specific data rate targets based on the updated data rate tolerances, wherein the managing is based on the updated RAT-specific data rate targets.

### Example 12

The method of any one of Examples 1 through 11, further comprising: detecting a change in the monitored second set of operational conditions; and updating the RAT-specific data rate targets based on the detected change; wherein the managing is based on the updated RAT-specific data rate targets.

### Example 13

A method of operating a processing system associated with a vehicle and configured to manage communications in accordance with a plurality of radio access technologies (RATs), comprising: monitoring a set of operational conditions associated with the processing system, the vehicle, or a combination thereof; establishing a dynamic prioritization of the plurality of RATs based on the monitored set of operational conditions; and managing data rates of the plurality of RATs based on the dynamic prioritization.

### Example 14

The method of Example 13, wherein the plurality of RATs comprises cellular vehicle-to-everything (C-V2X), and wherein the set of operational conditions includes: one or more in-cabin driving events of the vehicle, one or more exterior driving events of the vehicle, a RAT-related status of one or more applications configured for execution by the processing system, one or more custom settings defined by a third party, or any combination thereof.

### Example 15

The method of Example 13 or 14, further comprising: detecting a change in the monitored set of operational conditions; and updating the dynamic prioritization in accordance with the detected change, wherein the managing is based on the updated dynamic prioritization.

### Example 16

A processing system configured to manage communications in accordance with a plurality of radio access technologies (RATs), comprising: a memory; a transceiver; and at least one processor coupled to the memory and the transceiver and configured to: monitor a first set of operational conditions associated with the processing system, an external environment of the processing system, or a combination thereof; establish a dynamic prioritization of the plurality of RATs based on the monitored first set of operational conditions; determine a data rate tolerance of each of the plurality of RATs based at least in part on the dynamic prioritization; monitor a second set of operational conditions associated with the processing system, the external environment of the processing system, or a combination thereof; determine a RAT-specific data rate target for each of the plurality of RATs based at least in part on the determined data rate tolerances and the monitored second set of operational conditions; and manage data rates of the plurality of RATs based on the RAT-specific data rate targets.

### Example 17

The processing system of Example 16, wherein the first set of operational conditions includes: a RAT-related status of one or more applications configured for execution by the processing system, one or more custom settings defined by a third party, or any combination thereof.

### Example 18

The processing system of Example 16 or 17, wherein the processing system is associated with a vehicle, and wherein the plurality of RATs comprises cellular vehicle-to-everything (C-V2X).

### Example 19

The processing system of Example 18, wherein the first set of operational conditions includes: one or more in-cabin driving events of the vehicle, one or more exterior driving events of the vehicle, a RAT-related status of one or more applications configured for execution by the processing system, one or more custom settings defined by a third party, or any combination thereof.

### Example 20

The processing system of any one of Examples 16 through 19, wherein the second set of operational conditions includes: one or more performance metrics associated with the processing system, information characterizing a communicative status of the processing system, information characterizing an environment of the processing system, or any combination thereof.

### Example 21

The processing system of Example 20, wherein the one or more performance metrics include: a utilization level of the processing system, an operating frequency of the processing system, an idle duration level of the processing system, a power consumption level of the processing system, or any combination thereof.

### Example 22

The processing system of Example 20 or 21, wherein the information characterizing the environment of the processing system includes an amount of memory read traffic, write traffic, or a combination thereof.

### Example 23

The processing system of Example 20 or 21 or 22, wherein the information characterizing the environment of the processing system includes a temperature of a component of the processing system.

### Example 24

The processing system of any one of Examples 16 through 23, wherein the first and second sets of operational conditions are different.

### Example 25

The processing system of any one of Examples 16 through 24, wherein the data rate tolerance of each of the plurality of RATs corresponds to a degree of data rate reduction over the RAT that can be tolerated while maintaining a threshold RAT-specific user experience level, which is modeled as a function using the dynamic prioritization as an input.

### Example 26

The processing system of any one of Examples 16 through 25, wherein the at least one processor and the transceiver are further configured to: detect a change in the monitored first set of operational conditions; update the dynamic prioritization in accordance with the detected change; update the data rate tolerances based on the updated dynamic prioritization; update the RAT-specific data rate targets based on the updated data rate tolerances; and manage the data rates based on the updated RAT-specific data rate targets.

### Example 27

The processing system of any one of Examples 16 through 26, wherein the at least one processor and the transceiver are further configured to: detect a change in the monitored second set of operational conditions; update the RAT-specific data rate targets based on the detected change; and manage the data rates based on the updated RAT-specific data rate targets.

### Example 28

A processing system associated with a vehicle and configured to manage communications in accordance with a plurality of radio access technologies (RATs), comprising: a memory; a transceiver; and at least one processor coupled to the memory and the transceiver and configured to: monitor a set of operational conditions associated with the processing system, the vehicle, or a combination thereof; establish a dynamic prioritization of the plurality of RATs based on the monitored set of operational conditions; and manage data rates of the plurality of RATs based on the dynamic prioritization.

### Example 29

The processing system of Example 28, wherein the plurality of RATs comprises cellular vehicle-to-everything (C-V2X), and wherein the set of operational conditions includes: one or more in-cabin driving events of the vehicle, one or more exterior driving events of the vehicle, a RAT-related status of one or more applications configured for execution by the processing system, one or more custom settings defined by a third party, or any combination thereof.

### Example 30

The processing system of Example 28 or 29, wherein the at least one processor and the transceiver are further configured to: detect a change in the monitored set of operational conditions; update the dynamic prioritization in accordance with the detected change; and manage the data rates based on the updated dynamic prioritization.

### Example 31

An apparatus for wireless communication comprising a processor, memory coupled with the processor, the processor and memory configured to perform a method of any one of examples 1 through 15.

### Example 32

An apparatus for wireless communication comprising at least one means for performing a method of any one of examples 1 through 15.

### Example 33

A non-transitory computer-readable medium storing code for wireless communication comprising a processor, memory coupled with the processor, and instructions stored in the memory and executable by the processor to cause the apparatus to perform a method of any one of examples 1 through 15.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in a user device (e.g., a UE) or a base station. In the alternative, the processor and the non-transitory computer-readable medium may be discrete components in a user device or base station.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects, those skilled in the art will appreciate that various changes and modifications could be made herein without departing from the scope of the disclosure as defined by the appended claims. Furthermore, in accordance with the various illustrative aspects described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method of operating a processing system configured to manage communications in accordance with a plurality of radio access technologies (RATs), comprising:
monitoring a first set of operational conditions associated with the processing system, an external environment of the processing system, or a combination thereof;
establishing a dynamic prioritization of the plurality of RATs based on the monitored first set of operational conditions;
determining a data rate tolerance of each of the plurality of RATs based at least in part on the dynamic prioritization;
monitoring a second set of operational conditions associated with the processing system, the external environment of the processing system, or a combination thereof;
determining a RAT-specific data rate target for each of the plurality of RATs based at least in part on the determined data rate tolerances and the monitored second set of operational conditions; and
managing data rates of the plurality of RATs based on the RAT-specific data rate targets.

2. The method of claim 1, wherein the first set of operational conditions includes:
a RAT-related status of one or more applications configured for execution by the processing system,
one or more custom settings defined by a third party, or
any combination thereof.

3. The method of claim 1,
wherein the processing system is associated with a vehicle, and
wherein the plurality of RATs comprises cellular vehicle-to-everything (C-V2X).

4. The method of claim 3, wherein the first set of operational conditions includes:
one or more in-cabin driving events of the vehicle,
one or more exterior driving events of the vehicle,
a RAT-related status of one or more applications configured for execution by the processing system,
one or more custom settings defined by a third party, or
any combination thereof.

5. The method of claim 1, wherein the second set of operational conditions includes:
one or more performance metrics associated with the processing system,
information characterizing a communicative status of the processing system,
information characterizing an environment of the processing system, or
any combination thereof.

6. The method of claim 5, wherein the one or more performance metrics include:
a utilization level of the processing system,
an operating frequency of the processing system,
an idle duration level of the processing system,
a power consumption level of the processing system, or
any combination thereof.

7. The method of claim 5, wherein the information characterizing the environment of the processing system includes an amount of memory read traffic, write traffic, or a combination thereof.

8. The method of claim 5, wherein the information characterizing the environment of the processing system includes a temperature of a component of the processing system.

9. The method of claim 1, wherein the first and second sets of operational conditions are different.

10. The method of claim 1, wherein the data rate tolerance of each of the plurality of RATs corresponds to a degree of data rate reduction over the RAT that can be tolerated while maintaining a threshold RAT-specific user experience level, which is modeled as a function using the dynamic prioritization as an input.

11. The method of claim 1, further comprising:
detecting a change in the monitored first set of operational conditions;
updating the dynamic prioritization in accordance with the detected change;
updating the data rate tolerances based on the updated dynamic prioritization; and
updating the RAT-specific data rate targets based on the updated data rate tolerances,
wherein the managing is based on the updated RAT-specific data rate targets.

12. The method of claim 1, further comprising:
detecting a change in the monitored second set of operational conditions; and
updating the RAT-specific data rate targets based on the detected change;
wherein the managing is based on the updated RAT-specific data rate targets.

13. A method of operating a processing system associated with a vehicle and configured to manage communications in accordance with a plurality of radio access technologies (RATs), comprising:
monitoring a set of operational conditions associated with the processing system, the vehicle, or a combination thereof;
establishing a dynamic prioritization of the plurality of RATs based on the monitored set of operational conditions; and
managing data rates of the plurality of RATs based on the dynamic prioritization.

14. The method of claim 13,
wherein the plurality of RATs comprises cellular vehicle-to-everything (C-V2X), and
wherein the set of operational conditions includes:
one or more in-cabin driving events of the vehicle,
one or more exterior driving events of the vehicle,
a RAT-related status of one or more applications configured for execution by the processing system,
one or more custom settings defined by a third party, or
any combination thereof.

15. The method of claim 13, further comprising:
detecting a change in the monitored set of operational conditions; and
updating the dynamic prioritization in accordance with the detected change,
wherein the managing is based on the updated dynamic prioritization.

16. A processing system configured to manage communications in accordance with a plurality of radio access technologies (RATs), comprising:
a memory;
a transceiver; and
at least one processor coupled to the memory and the transceiver and configured to:
monitor a first set of operational conditions associated with the processing system, an external environment of the processing system, or a combination thereof;
establish a dynamic prioritization of the plurality of RATs based on the monitored first set of operational conditions;
determine a data rate tolerance of each of the plurality of RATs based at least in part on the dynamic prioritization;
monitor a second set of operational conditions associated with the processing system, the external environment of the processing system, or a combination thereof;
determine a RAT-specific data rate target for each of the plurality of RATs based at least in part on the determined data rate tolerances and the monitored second set of operational conditions; and
manage data rates of the plurality of RATs based on the RAT-specific data rate targets.

17. The processing system of claim 16, wherein the first set of operational conditions includes:
a RAT-related status of one or more applications configured for execution by the processing system,
one or more custom settings defined by a third party, or
any combination thereof.

18. The processing system of claim 16,
wherein the processing system is associated with a vehicle, and
wherein the plurality of RATs comprises cellular vehicle-to-everything (C-V2X).

19. The processing system of claim 18, wherein the first set of operational conditions includes:
one or more in-cabin driving events of the vehicle,
one or more exterior driving events of the vehicle,
a RAT-related status of one or more applications configured for execution by the processing system,
one or more custom settings defined by a third party, or
any combination thereof.

20. The processing system of claim 16, wherein the second set of operational conditions includes:
one or more performance metrics associated with the processing system,
information characterizing a communicative status of the processing system,
information characterizing an environment of the processing system, or
any combination thereof.

21. The processing system of claim 20, wherein the one or more performance metrics include:
a utilization level of the processing system,
an operating frequency of the processing system,
an idle duration level of the processing system,
a power consumption level of the processing system, or
any combination thereof.

22. The processing system of claim 20, wherein the information characterizing the environment of the processing system includes an amount of memory read traffic, write traffic, or a combination thereof.

23. The processing system of claim 20, wherein the information characterizing the environment of the processing system includes a temperature of a component of the processing system.

24. The processing system of claim 16, wherein the first and second sets of operational conditions are different.

25. The processing system of claim 16, wherein the data rate tolerance of each of the plurality of RATs corresponds to a degree of data rate reduction over the RAT that can be tolerated while maintaining a threshold RAT-specific user experience level, which is modeled as a function using the dynamic prioritization as an input.

26. The processing system of claim 16, wherein the at least one processor and the transceiver are further configured to:
detect a change in the monitored first set of operational conditions;
update the dynamic prioritization in accordance with the detected change;
update the data rate tolerances based on the updated dynamic prioritization;
update the RAT-specific data rate targets based on the updated data rate tolerances; and
manage the data rates based on the updated RAT-specific data rate targets.

27. The processing system of claim 16, wherein the at least one processor and the transceiver are further configured to:
detect a change in the monitored second set of operational conditions;
update the RAT-specific data rate targets based on the detected change; and
manage the data rates based on the updated RAT-specific data rate targets.

28. A processing system associated with a vehicle and configured to manage communications in accordance with a plurality of radio access technologies (RATs), comprising:
a memory;
a transceiver; and
at least one processor coupled to the memory and the transceiver and configured to:
monitor a set of operational conditions associated with the processing system, the vehicle, or a combination thereof;
establish a dynamic prioritization of the plurality of RATs based on the monitored set of operational conditions; and
manage data rates of the plurality of RATs based on the dynamic prioritization.

29. The processing system of claim 28,
wherein the plurality of RATs comprises cellular vehicle-to-everything (C-V2X), and
wherein the set of operational conditions includes:
one or more in-cabin driving events of the vehicle,
one or more exterior driving events of the vehicle,
a RAT-related status of one or more applications configured for execution by the processing system,
one or more custom settings defined by a third party, or
any combination thereof.

30. The processing system of claim 28, wherein the at least one processor and the transceiver are further configured to:
detect a change in the monitored set of operational conditions;
update the dynamic prioritization in accordance with the detected change; and
manage the data rates based on the updated dynamic prioritization.
